(19) United States
(12) Patent Application Publication
(10) Pub. No.: US 2007/0255579 A1
(43) Pub. Date: Nov. 1, 2007

(54) METHOD AND SYSTEM FOR RECORDING INTERACTIONS OF DISTRIBUTED USERS

(76) Inventors: Conor T. Boland, Dublin (IE); Marie Helene Brohan Delhave, Dublin (IE); Garreth Browne, Dublin (IE); Liang Chen, Shanghai (CN); Patrick J. O'Sullivan, Dublin (IE)

Correspondence Address: HOFFMAN, WARNICK & D'ALESSANDRO LLC, 75 STATE ST, 14TH FLOOR, ALBANY, NY, 12207, US

(21) Appl. No.: 11/549,997

(22) Filed: Oct. 17, 2006

(30) Foreign Application Priority Data
Apr. 28, 2006 (GB) 0608404.0

(51) Int. Cl. G06Q 10/00; G06Q 30/00

(52) U.S. Cl. 705/1

(57) ABSTRACT

A method and system are provided for recording interactions of distributed users in a distributed system. A plurality of distributed clients each interact with a system of interest. A shared network file is provided which is accessible by each of the distributed users. A recorder records a client's use activity on the system of interest as a record in the shared network file. The records of multiple clients are combined in an interleaved, time ordered record.

### FIELD OF THE INVENTION

This invention relates to the field of recording user system interactions. In particular, it relates to recording user system interactions by distributed users in a distributed system to facilitate problem determination in enterprise computing systems.

### BACKGROUND OF THE INVENTION

While working on a computer system, a user may not be aware of problems in the background, as from an end-user perspective all looks fine. In the background, system logs demonstrate problems, exceptions thrown, deadlocks seen, etc. In a distributed team, where multiple users work on a shared enterprise computing system, this problem is compounded, as the build up of many issues occurring in the backend infrastructural sub-systems can go unnoticed until these problems reach a level that starts causing errors that appear to the user. Likewise, errors that happen passively and without the end users' knowledge can be fundamental, and indicative of more systemic problems. Oftentimes, such errors can lead to system down time.

Software systems generate logs that contain data listing events, exceptions and errors recorded by the system. These logs are used in order to determine the root cause of a problem. However, the events and problems recorded in the system logs are not correlated to the functions exercised by the user or users who are operating on the system. It is therefore difficult to ascertain root cause analysis. Analysis of system logs generally takes place after the event, sometimes hours or days later. At that point, it is difficult to correlate the errors listed in the system logs with the use cases performed by the users on the system. This makes the process of problem determination slow and difficult. In particular, complexity is amplified when a distributed user group are using a distributed computing system, which comprises many infrastructural components (e.g. database, LDAP, proxy server, policy server, http server, application server, clusters) that have many interrelationships and dependencies.

For example: A test engineer examines the system logs on a Friday. System logs on a test application show “Out Of Memory” errors building up from 10 am from the previous Thursday. Without knowing what use cases were being exercised at that point in time, it is difficult to know what the root cause of the “Out Of Memory” exceptions is. The test engineer has probably not kept a precise enough log of what functions he was testing at 10 am on the Thursday to understand what happened. Indeed, in a large distributed user group it would be a non-trivial effort to have each user record each use case for all use cases executed. In this example, a record of the user interactions at that point would show that 100 users were trying to save a response to a topic in a team room, pointing to a fault in a particular sub-system in the enterprise computing system. With this extra information the test engineer would have been able to narrow down his investigation of the problem a lot faster.

Without precise information of what use cases were being executed at the time of the error, it is very difficult for system testers to provide enough information for the software developers to narrow down their investigation of the problem and to debug the system. In a distributed system that has many infrastructural components the challenge is increased exponentially, as there are many moving parts in play.

There are a number of test applications that provide a way to track user interactions with an application, for instance IBM Rational Robot & Test Manager, Mercury Interactive LoadRunner & Mercury End User Monitoring, Compuware QACenter & Compuware Vantage. (IBM and Rational are trade marks of International Business Machines Corporation in the United States and/or other countries; Mercury, Mercury Interactive and LoadRunner are trade marks of Mercury Interactive Corporation in the United States and/or other countries; Compuware QACenter and Vantage are trade marks of Compuware Corporation in the United States and/or other countries.)

With these products, a subset of expected user activity on a system is recorded and played back by virtual users, thereby simulating user activity. This recorded activity is referred to as a “use case”. For example, in an email system, a “use case” could be created for sending an email with attachment. This use case would contain all the steps that need to be taken by a user to send an email with a file attached to it, including composing the email, spell-checking it, attaching the file, and finally sending it. These products keep a record of all the played-back user activity and failures that affect the user.

However, these products do not link the end-user failures to the automatically-generated system logs. It is therefore difficult to associate a specific end-user activity with a specific event or error in the system logs. Manually correlating the failures appearing to the end user with the exceptions recorded in the system logs is a time-consuming process, as the two aspects are not synchronised.

More significantly, these products are used to simulate use cases that are executed in an automated way. It is neither practical nor desirable to automate every possible use case. Important points related to variability are therefore not considered. For example, use cases that may be executed that may not be deemed significant enough to automate, but result in a failure that is important to resolve.

Each of the elements of a system (Application Server, LDAP Server, Database Server, HTTP Server, etc.) produces a specific system and error log, listing all exceptions recorded by the system. These numerous logs can be interleaved, for instance, by using the IBM Log and Trace Analyser. Even with this interleaving of logs, however, it is clear that the amount of data provided to an engineer trying to find the root cause of a problem is very large.

The sheer volume of data makes it hard to find the root cause of a defect. This problem is compounded by the difficulty in correlating this log data to the user interactions on the system. It is an aim of the present invention to bridge this gap.

### SUMMARY OF THE INVENTION

According to a first aspect of the present invention there is provided a method for recording interactions of distributed users in a distributed system, comprising: recording a record of a client's use activity on a system of interest; storing the record to a shared network file on the distributed system; and combining the records of multiple clients in an interleaved, time ordered record.

Preferably, the method includes: recording an error in component logs of the system of interest; and correlating by time an error in the system of interest with the interleaved, time ordered record.

The user interactions may be recorded in a common base event (CBE) format in the shared file and the record may include at least one of: an identification of a user; applications running on a computer system of the user; a current operating system of the user, version; service pack; and a location and language of the user. A set of interactions by a user may be identified by a use case identifier.

In one embodiment, the system of interest is a system under test and the multiple clients' use activities are simulated by a test application. The method may be activated for a test case, and a group of related use cases by a plurality of clients may be identified by a test case identifier.

In another embodiment, the system of interest is a system in use and each client publishes the record of its use activity to the shared network file.

According to a second aspect of the present invention there is provided a system for recording interactions of distributed users in a distributed system, comprising: a plurality of distributed clients each interacting with a system of interest; a shared network file accessible by each of the distributed clients; a recorder for recording a client's use activity on the system of interest as a record in the shared network file; and means for combining the records of multiple clients in an interleaved, time ordered record.

Preferably, the system includes: an analyser for analysing component logs of the system of interest; and a correlation means for correlating the component logs to the interleaved, time ordered record.

The clients' use activities may be recorded in a common base event (CBE) format in the shared network file and the record may include at least one of: an identification of a user; applications running on a computer system of the user; a current operating system of the user, version; service pack; and a location and language of the user. A client's use activity may be identified by a use case identifier.

In one embodiment, the system of interest may be a system under test and the multiple clients' use activities may be simulated by a test application. The system may include a test case database, and wherein the recorder may be launched to record a new test case and may interface with the test case database. A group of related use cases by a plurality of clients may be identified by a test case identifier.

In another embodiment, the system of interest may be a system in use and each client may have a recorder which publishes the record to the shared network file.

According to a third aspect of the present invention there is provided a computer program product stored on a computer readable storage medium, comprising computer readable program code for performing the steps of: recording a record of a client's use activity on a system of interest; storing the record to a shared network file on the distributed system; and combining the records of multiple clients in an interleaved, time ordered record.

### BRIEF DESCRIPTION OF THE DRAWINGS

Embodiments of the present invention will now be described, by way of examples only, with reference to the accompanying drawings.

FIG. 1 is a block diagram of a system of interest as known in the prior art.

FIG. 2 is a block diagram of a first embodiment of a distributed computer system in accordance with the present invention.

FIG. 3 is a block diagram of a second embodiment of a distributed computer system in accordance with the present invention.

FIG. 4 is a schematic diagram of a process in accordance with the present invention.

FIG. 5 is a flow diagram of a method in accordance with the present invention.

### DETAILED DESCRIPTION OF THE INVENTION

Recording multiple, distributed user interactions with a system can provide detailed information on the cause of problems or failures of the system. A system with which multiple, distributed users are interacting may take many different forms.

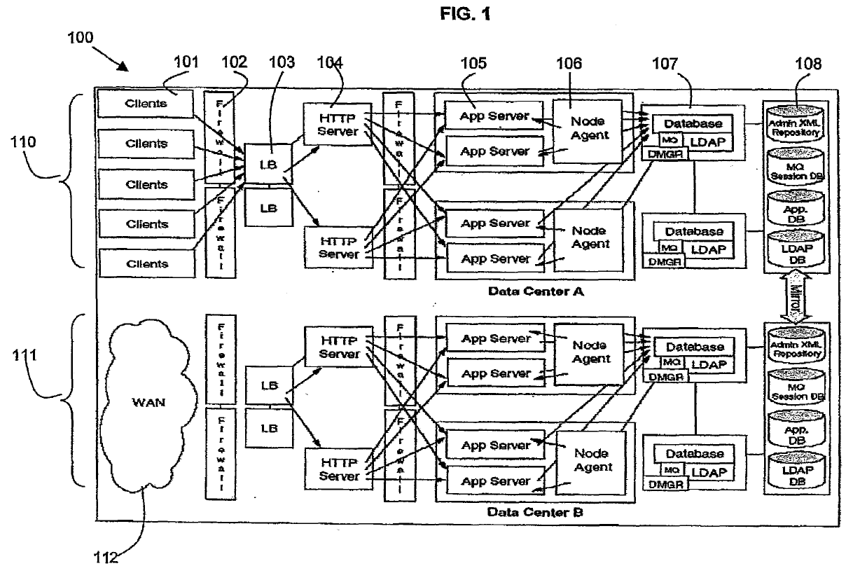

For example, the system may be an enterprise environment which is scaled vertically and horizontally resulting in a large infrastructure with many different parts. FIG. 1 shows an example of a system 100 with which multiple, distributed users may interact. The system 100 has an infrastructure including multiple clients 101, firewalls 102, load balancers 103, HTTP (hypertext transfer protocol) servers 104, application servers 105, node agents 106, database servers 107, and databases 108. The system 100 includes multiple data centers 110, 111 all connected via LANs (local area networks) or WANs (wide area network) 112. Although FIG. 1 shows one such enterprise computing system infrastructure it is clear that many combinations of enterprise computing infrastructure are possible in 1, 2, . . . , N-tiered architectures.

Each of the elements of the system produces a specific system and error log listing all exceptions recorded by the system. These numerous logs can be interleaved by using a log trace analyzer (for example, IBM Log and Trace Analyser, IBM is a trade mark of International Business Machines Corporation in the United States and/or other countries).

Users interacting with the system may perceive that their use is problem-free; however, their use alone or in combination with other users may be resulting in unseen problems.

These problems may be systemic and may take the following example forms.
Casual failures such as Java exceptions (Java is a trade mark of Sun Microsystems, Inc. in the United States and/or other countries), basic sub-system errors, incidental print out error messages, which are not of great concern.
With multiple users, problems may include shared resource utilization or access problems such as directory problems, database deadlocks, serialization concerns, thread pool starvation issues etc. These shared user problems may not be evident if the users succeed; however, issues like deadlock problems need to be addressed as more systemic failures are inevitable in situations where more users would attempt to access shared resource simultaneously and concurrently.
Another example of a systemic problem relates to garbage collection. Garbage collection in J2EE infrastructures (Java 2 Platform Enterprise Edition, Java and J2EE are trade marks of Sun Microsystems, Inc. in the United States and/or other countries) may either be at too great a frequency or may take too long to complete, and such problems will impact performance and system reliability.
Also a slow loss of memory may not be a problem in a test case; however, in production environments this will lead to catastrophic failures.
Likewise, resource consumption (e.g. CPU, memory, disk, thread pools, etc) are also important to address.

The described method and system provide a mechanism for recording in a linear time order the interleaved user activities of multiple distributed users of a system. The distributed users may be executing a test of the system by interacting with a set of pre-canned test cases housed in a test management infrastructure, or users may be piloting the system as part of a pre-production test, or users may be actual users of a real production system.

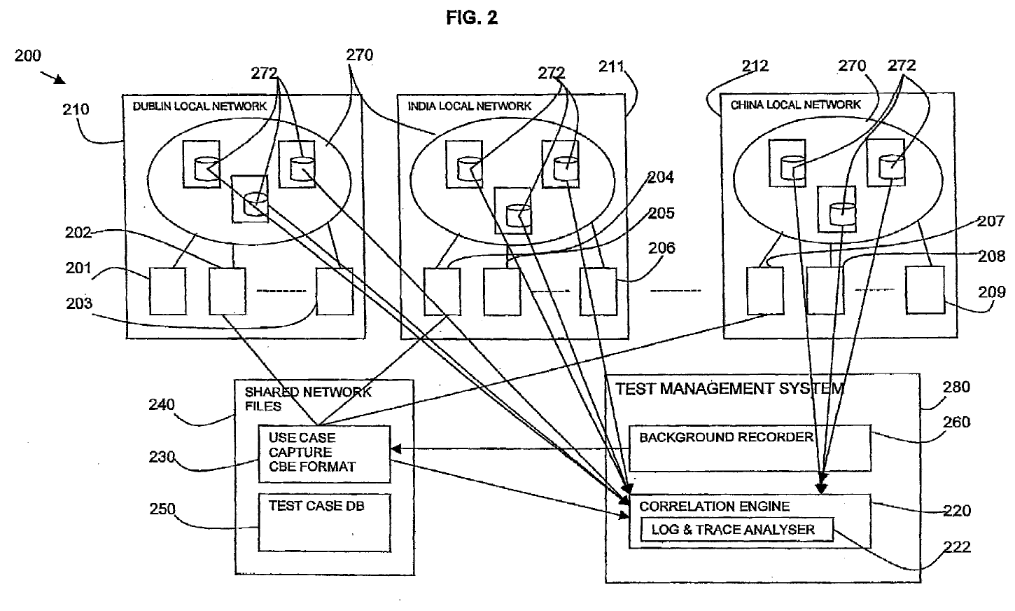

In a first embodiment of the described method and system an infrastructure is described with distributed users acting in accordance with a test management system to test a system. Referring to FIG. 2, a distributed computer environment 200 is shown for testing a system 270.

The distributed computer environment 200 may be an enterprise system with multiple local infrastructures 210, 211, 212 connected by local network system distributed geographically across different towns, countries, or continents. For example, in FIG. 2, a first local infrastructure 210 may be a Dublin infrastructure in Ireland using a local network, a second local infrastructure 211 may be in India, and a third local infrastructure 212 may be in China.

The local infrastructures 210, 211, 212 provide local speed, autonomy, etc. Each of the local infrastructures 210, 211, 212 replicate and interact with the other local infrastructures 210, 211, 212 to keep one another up to date based on changes made locally, which are then propagated and replicated.

For example, a distributed enterprise computing system for mail would have local infrastructures as described above.

A system under test 270 is a distributed enterprise computing system or a part or sub-system of such a system.

Distributed enterprise users 201-209 access a distributed enterprise system and are clients which gain access to the enterprise servers across networks such as LANs or WANs. The computer environment 200 is an N-tiered application server infrastructure that can have a large number of infrastructural parts.

A user 201-209 may access an HTTP server which in turn routes the user to the application server. Access from then on, to the other infrastructural components, may be provided by the application server on behalf of the user 201-209. Alternatively direct access or proxied access are also possible, but conventionally through a mediating infrastructural sub-system on behalf of the user. This means that problem determination is difficult as there are various components, only one of which the user has direct access to, access to the others being by the system and not the user.

An aim of the described method and system is to associate a failure seen in any part of a system under test 270 or in a system log, with the exact use case by one of the clients 201-209 that was responsible for this failure, and the reasons and accountability for the failure in an n-tiered architecture. In situations where a combination of use cases running concurrently have contributed to the failure then an aim of the described method and system is to provide this knowledge. This is done across all the distributed infrastructural parts of the computer environment 200 in a way that allows the identification of the source of a problem regardless of the number of users 201-209 that were using a system 270 at that point in time.

A test management system 280 holds decisions that testers wants to execute and test on the system 270. The test management system 280 prioritises test cases across different installations and facilitates scheduling around configurations of platforms, databases, etc. The test management system 280 includes a test case database 250 which stores details of the tests that are planned in the form of client use cases which are the intended interactions of one or more clients with the system 270. These use cases represent the documented use case decisions that a tester will verify as part of the testing exercise. The test case database 250 is accessed by users 201-209 to select a test for execution. Therefore, the test case database 250 may be provided on a shared place on the network 240. Typically, an enterprise test management system may house several thousand test cases. Test management systems that are being used to facilitate testing of enterprise computing systems may house tens of thousands of test cases.

A background recorder application 260 launches on behalf of each user and interfaces with the test management infrastructure, recording and analysing interactions from the distributed users 201-209 in a system 270.

The users' 201-209 intention and fulfilment of use cases are captured in a use case capture file 230 which is a central file accessible by all users 201-209 that lives on a shared place on the network 240, typically a server. FIG. 2 shows the test case database 250 and the capture file 230 in the same location; however, these may be provided in different locations.

Interactions are recorded in the capture file 230 with the precise time of exploitation using a Common Base Event (CBE) format. A CBE format defines the structure of an event in a consistent and common format facilitating the effective intercommunication across enterprise components that support logging, management, problem determination, autonomic computing, etc. A user's 201-209 intention and fulfilment in a use case can be submitted to a servlet and written to the capture file 230, directly submitted by the recorder via a direct socket or HTTP connection, or placed in a queue that is processed in a FIFO (first in first out) way.

The capture file 230 is a common store for all use cases in a test case that is aggregated with a linear time stamp and stored centrally. The probability of collision between users is very low as the millisecond level of granularity of the time used to record use case events is used. The capture file 230 may be aggregated from use case events in real time as the events are recorded.

Each group of user actions from users 201-209 are stored as “test cases” in the capture file 230, thereby keeping a precise record of user interactions with the system 270.

The background recorder application 260 launches upon request, runs in the background, and stores the user interactions as use cases along with the associated time of interaction in the capture file 230. When launched, the background recorder application 260 creates a unique ID number for the test case. The set of activities recorded when the background recorder application 260 is started is stored under the test case bearing this ID number.

In a distributed system, all users 201-209 have the ability to write to this as a shared file 240, thereby providing a complete picture of activity on the system 270 at a specific point in time.

The information written includes the log-on identity of the user 201-209, along with the action performed and the time of the interaction. Specifics of the user's local environment such as the operating system type, version, language, time zone, other applications running at the same time, etc., can also be included in the information posted in the use case capture file 230.

In an example implementation, the information provided could be:
Start time: [May 10, 2005 17:45:31:164]
Test Case Unique ID number: XX000YY111ZZZ
User: Joe_Blogs@ie.ibm.com
Activity: Send mail with 3 MB attachment (Each step of the activity is recorded in this use case, with the precise time for each step)
Operating System: Windows XP Professional
Applications running: Symantec antivirus, Lotus Sametime Connect, Lotus Notes, AT&T Network Client, . . .
End time: [May 11, 2005 18:00:22:112]
   (Windows XP Professional is a trade mark of Microsoft Corporation in the United States and/or other countries; Lotus, Sametime, and Notes are trade marks of International Machines Corporation in the United States and/or other countries; Symantec is a trade mark of Symantec Corporation in the United States and/or other countries.)

The software system 200 to be tested generates logs 272 that contain data listing events, exceptions and errors recorded by the system. These logs 272 are used in order to determine the root cause of a problem. Each of the elements of a system (for example, the application server, LDAP server, database server, HTTP server, etc.) produces a specific system and error log 272, listing all exceptions recorded by the system. These numerous logs 272 can be interleaved using a log analyser.

In conventional systems, the events and exceptions recorded in the system logs 272 are not correlated to the functions exercised by the user(s) 201-209. Analysis of system logs 272 generally takes place after the event, sometimes hours or days later. At that point, it is difficult to correlate the exceptions listed in the system logs 272 with the functions exercised by the users 201-209 on the system.

The described system 200, provides a correlation engine 220 which provides correlation between the system logs 272 and the capture file 230 for a test case in linear time stamped order in CBE format created from the recorder 260. The correlation engine 220 uses a log and trace analyser 222.

Any failures logged in the system logs 272 can be correlated to user 201-209 activities that took place on the system 270 at that point in time, as well as the user identity and any other user information.

In a first embodiment, the method and system are used in a test management system 280 in which a test application is used to perform functional testing of client/server applications. With a test management system 280, a subset of expected user activity on a system is recorded and played back by virtual users, thereby simulating user activity.

In FIG. 2, the various components of the background recorder application 260 and a correlation engine 220 are shown as part of a test management system 280; however, one or more of these components may be located on another system and may be accessed remotely.

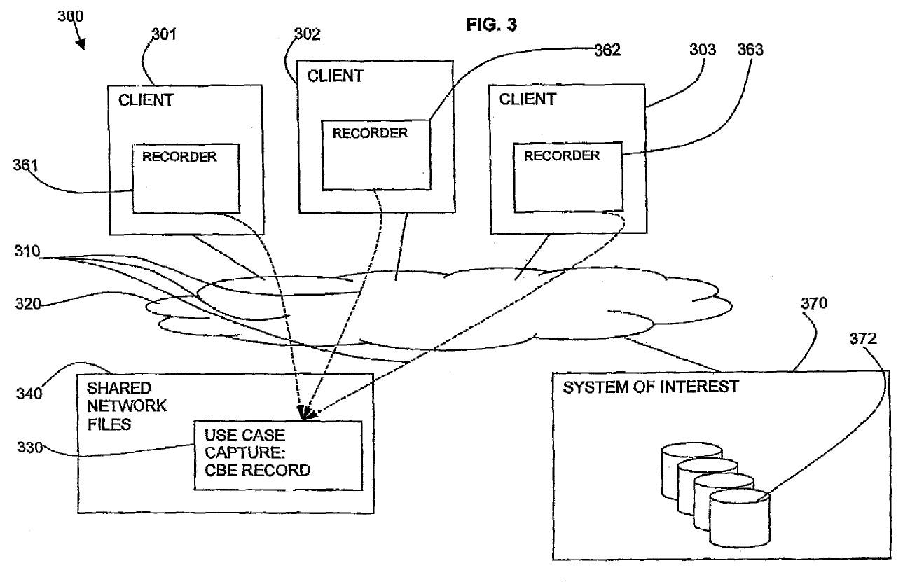

In a second embodiment of the described method and system, an infrastructure is described with distributed users in actual use of a system rather than as test users as in the first embodiment. Referring to FIG. 3, a distributed computer environment 300 is shown with a plurality of clients 301-303 communicating with a system 370 via a network 320. Each client 301-303 or a sub-set of clients has a background recorder 361-363.

The users 301-303 in the second embodiment, may be piloting a system 370. In a test management system, the number of test scenarios that can be run is limited; however, when a system is piloted in use, many more use cases arise which may result in errors in the system 370.

In another scenario, the users 301-303 in the second embodiment may be end users of the system 370. For example, a customer may be encountering problems with the system 370 that cannot be identified, and the customer may be shipped the background recorder 361-363 for the clients 301-303 to use to determine the cause of the customer's problems.

The background recorder 301-303 does not interface with a test case database as in the first embodiment, but records each client's 301-303 intention and fulfilment of use cases in a passive background manner and publishes 310 the recorded events to a common base event file 330 on shared network files 340. The CBE file 330 is converted to an interleaved record which combines the users' use cases and events published from the background recorders 361-363 in a linear time stamped record.

The linear time stamped record can be correlated with the results of system logs 372 of the system 370 being used by means of a correlation engine using a log trace analyser.

The use cases published by the background recorders 361-363 provide enough information relating to the clients' use activity without contravening the clients' confidentiality. For example, if the use case is sending an email message, the published information will note the address, time, size, recipient, etc. of the message without disclosing the contents of the message.

The output from users 301-303 comprising common base events furnishing specifics about the user's intention along with the user's operating credentials can be consolidated in one central place for all users with a view to facilitating post-hoc correlation regardless of the users' physical locations. This can be carried out in real time, providing problem correlation on-the-fly, if required.

In this second embodiment, the recording can be extended to any type of use case that a given user would exploit and does not require the analysis to be deterministic. As in the first embodiment, at a specific point in time or at the end of a time period (such as a day, week, etc.) the CBE data generated can be correlated with other infrastructural logs and allows for precise correlation of failures to users' actions across a distributed user community. Moreover, in high concurrency situations the CBE data can be used to identify with a high degree of precision which users or combination of users (in the event of proximate-collision) contributed to failures on the system 370.

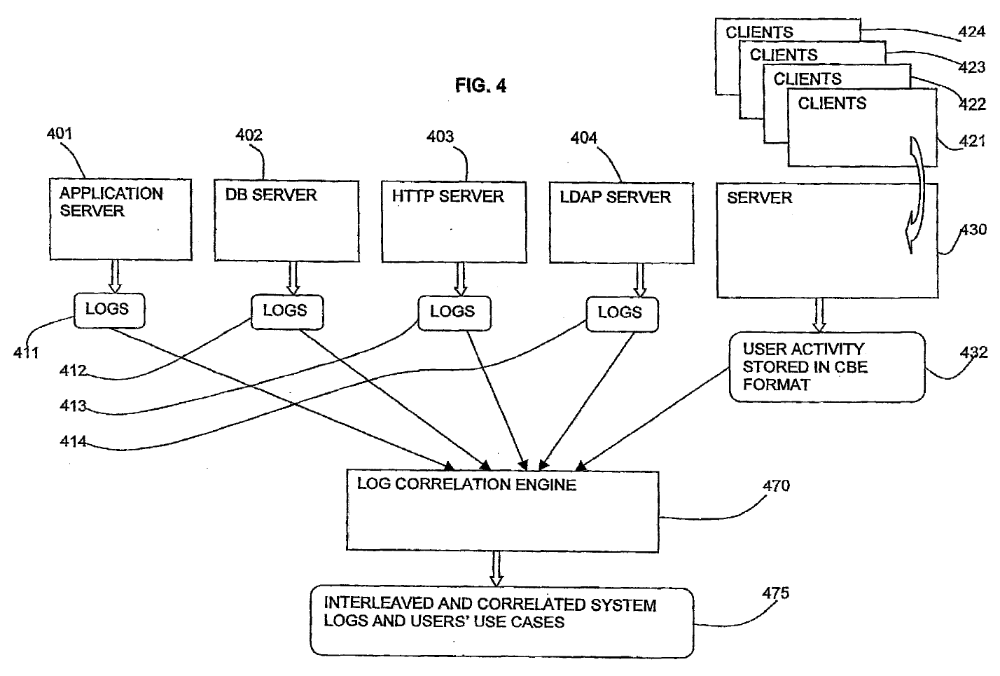

Referring to FIG. 4, a schematic representation of both the first and second embodiments is provided. System components of a system under test 270 or in use 370 such as an application server 401, a database server 402, an HTTP server 403, and an LDAP server 404 each have logs 411, 412, 413, 414 which record events, errors and exceptions of the components 401-404.

In addition, clients 421-424 publish their use cases (the intent and the fulfilment of the event) to a server 430 which are stored in as an interleaved record 432 in CBE format for all the clients 421-424 in a time stamped order.

A log correlation engine 470 correlates the contents of the logs 411-414 and the interleaved record 432 to provide an output 475 which is all system logs and all users' use cases interleaved and correlated by date and time.

Precision of correlation is reached when the users' time 421-424 and the system's 270, 370 time are synchronised. The background recorder application is time zone independent and publishes the use cases and associated data in UTC (Coordinated Universal Time). This means that post-hoc correlation can be auto-adjusted to any of the server times.

The system and method described allow multiple users across multiple sites to record data in a common/shared central file, therefore giving the ability to achieve post-hoc correlation for all of the users' interactions/use cases. Due to a centralized store, distributed users can write to a shared file in an interleaved way. The sequence of events is therefore time-ordered (UTC) and event-ordered (as they happen). This is an important criteria in problem determination.

In a test management use, the background recorder application runs on demand when a test engineer wants to trigger the execution of a new test case. This applies to test environments, where a test engineer applies this methodology to run test cases and keep a record of all user interactions in order to correlate these to system logs after the test case has been completed. This provides sufficient information to a software developer who will be assigned the task of providing a solution to the defects found by the test engineer.

The described system and method permits an end-user to interface with their preferred test case database in a way that results in the recording of user events with a view to assisting in post-hoc correlation for problem determination purposes. Amplifying this problem in a software development team with an understanding of the exact user interactions for all use cases is useful and pertinent.

The background recorder application described is not intrusive and is intended to furnish additional detail beyond the use case. The use case on its own, along with the date and time of its exploitation, is useful. However, the optional amplification of context is provided by automatically supplementing the use case with additional information that can be furnished from the client system. This additional information includes, but not limited to:
The use case in the test tracking system, along with the time and date of exploitation.
The unique test case ID representing the use case that the user intends to run, as well as a one-line summary on the use case.
The start and end time of the test. A proposed embodiment of this records the median of these two times in the CBE file created, as this is likely to be very useful for post-hoc correlation.
The user name, IP address and present location which are available from interrogating the local client system.
Applications and processes running on the user's desktop. In problem situations, information on applications used at the time is valuable, e.g. what browser was being used, what service pack, what version, what processes, etc . . . This includes the application name, version information from the application, available data on memory/CPU/state of the application as given by the system.
The user's current operating system, version, service pack.
Any language or locale information. Very often, extensive problem determination efforts conclude that errors are associated with application assumption in date, time or language.

The described method can also be applied to an environment with automation tools that simulate the actions of a single user. In some situations, where multi-user automation cannot be used or is not available for the particular environment, it is necessary to use multiple instances of clients running a single-user automation tool. The described method can be used to correlate the failures encountered on the multiple clients.

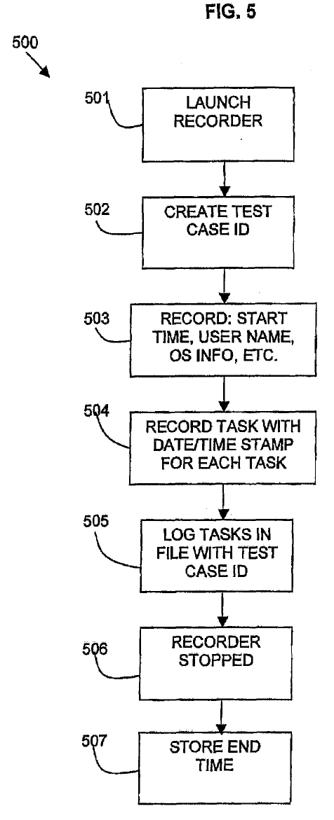

The method of operation of the system is described with reference to FIG. 5 which shows a flow diagram 500 of the method steps carried out by the background recorder application.

In the embodiment of test management user, a test engineer logs on to system and launches the recorder 501. The recorder creates a unique test case ID number 502. The recorder records the start time, user name, operating system information, etc. 503.

The test engineer starts interacting with the system, carrying out the tasks he wants to include in his test case. For example, a test case to test “open email”: the user logs on to his system, goes into his email inbox and opens an email that has recently been received.

Each task carried out by the test engineer is recorded 504 by the recorder, with a date and time stamp assigned for each task. The log of these tasks is recorded into a file which bears the test case ID number, using the CBE format 505.

In the case of one test case that applies to many users, all carrying out a number of different tasks, the data for all the users interacting with the system is stored in a single file, bearing the test case ID number.

When all the tasks that the test engineer wants to record as part of this particular test case have been executed, the test engineer stops the recorder 506. The recorder records the end time 507.

Each test case file is kept in a database, from where it can easily be retrieved by using the unique ID number.

The test engineer goes through the system logs to find exceptions and errors recorded by the system. For each exception or error found, the test engineer opens the file bearing the test case ID number, and finds the exact functions that were being exercised at the time.

The correlation of system logs with the user actions can be automated by a correlation application or can be carried out manually. By correlating the events, exceptions or errors reported in the system log at a particular time with the user actions on the system at that particular time, the test engineer will get a full picture of what is happening, therefore gaining a better understanding of the events leading to an error condition. The test engineer will then be able to provide this information to the software developer tasked with fixing the defects in the application.

The described method and system enable a use case that has been executed in a distributed enterprise computing infrastructure to be deterministically identified. Unique characteristics of the user's system, regardless of the platform or location of the user, are automatically and passively identified to assist in problem determination.

In distributed user environments where a plurality of users converge on a shared enterprise system and problems are seen, it is very difficult to assess the owner of the problem, and the set of circumstances and use cases that resulted in this problem. For example, a user in China may be working on a system in Dublin where his particular browser version results in a set of J2EE exceptions in one of the system logs. Meanwhile, while 50 other users are exploiting different user cases at the same time on different client platforms and browsers. The described method and system enable an analysis to determine that the user in China is the cause of the exceptions, regardless of the number of infrastructural components involved in the enterprise computing system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

1. A method for recording interactions of distributed users in a distributed system, comprising:
recording a record of a client's use activity on a system of interest;
storing the record to a shared network file on the distributed system; and
combining the records of multiple clients in an interleaved, time ordered record.

2. The method as claimed in claim 1, further comprising:
recording an error in component logs of the system of interest; and
correlating by time an error in the system of interest with the interleaved, time ordered record.

3. The method as claimed in claim 1, wherein the client's use activity is recorded in a common base event (CBE) format in the shared network file.

4. The method as claimed in claim 1, wherein the record includes at least one of: an identification of a user; applications running on a computer system of the user; a current operating system of the user, version; service pack; and a location and language of the user.

5. The method as claimed in claim 1, wherein a set of interactions by a user is identified by a use case identifier.

6. The method as claimed in claim 1, wherein the system of interest is a system under test and wherein the use activities of the multiple clients are simulated by a test application.

7. The method as claimed in claim 6, wherein the method is activated for a test case, and wherein a group of related use cases by a plurality of clients is identified by a test case identifier.

8. The method as claimed in claim 1, wherein the system of interest is a system in use and each client publishes the record of its use activity to the shared network file.

9. A system for recording interactions of distributed users in a distributed system, comprising:
a plurality of distributed clients each interacting with a system of interest;
a shared network file accessible by each of the distributed clients;
a recorder for recording a client's use activity on the system of interest as a record in the shared network file; and
means for combining the records of multiple clients in an interleaved, time ordered record.

10. The system as claimed in claim 9, including:
an analyser for analysing component logs of the system of interest; and
a correlation means for correlating the component logs to the interleaved, time ordered record.

11. The system as claimed in claim 9, wherein the clients' use activities are recorded in a common base event (CBE) format in the shared network file.

12. The system as claimed in claim 9, wherein the record includes at least one of: an identification of a user; applications running on a computer system of the user; a current operating system of the user, version; service pack; and a location and language of the user.

13. The system as claimed in claim 9, wherein a client's use activity is identified by a use case identifier.

14. The system as claimed in claim 9, wherein the system of interest is a system under test and the use activities of the multiple clients are simulated by a test application.

15. The system as claimed in claim 14, further comprising:
a test case database;
wherein the recorder is launched to record a new test case and interfaces with the test case database.

16. The system as claimed in claim 14, wherein a group of related use cases by a plurality of clients is identified by a test case identifier.

17. The system as claimed in claim 9, wherein the system of interest is a system in use and wherein each client has a recorder which publishes the record to the shared network file.

18. A computer program product stored on a computer readable storage medium, comprising computer readable program code for performing the steps of:
recording a record of a client's use activity on a system of interest;
storing the record to a shared network file on the distributed system; and
combining the records of multiple clients in an interleaved, time ordered record.
